(19) United States
(12) Patent Application Publication
(10) Pub. No.: US 2020/0265398 A1
(43) Pub. Date: Aug. 20, 2020

(54) POINT OF SALE MODULAR PROCESSOR SYSTEM

(71) Applicant: CyberData Corporation, Monterey (CA)

(72) Inventor: Phil Lembo, Pebble Beach, CA (US)

(21) Appl. No.: 16/791,958

(22) Filed: Feb. 14, 2020

Related U.S. Application Data
(60) Provisional application No. 62/806,672, filed on Feb. 15, 2019.

(51) Int. Cl. G06Q 20/20; G06F 1/26

(52) U.S. Cl. CPC G06Q 20/202; G06F 1/266

(57) ABSTRACT

A system and method are described for a point of sale (POS) processor system comprising a computing device, a power supply unit, and a USB hub that includes multiple USB ports that conform to the PoweredUSB standard. The power supply unit is coupled to the USB hub and includes an internal or external power supply to distribute power to the poweredUSB ports and the computing device. The USB hub includes multiple poweredUSB ports that are configured to deliver power and data connectivity to peripheral devices. The USB hub provides a connection to facilitate the transfer of data between the computing device coupled to and powered by the USB hub and any peripheral devices connected to the poweredUSB ports.

### BENEFIT CLAIM

This application claims the benefit of provisional application 62/806672, filed Feb. 15, 2019, the entire contents of which is hereby incorporated by reference as if fully set forth herein, under 35 U.S.C. § 119(e).

### FIELD OF THE INVENTION

The present invention relates to power control point-of-sale (“POS”) interfaces with universal serial bus (USB) connectivity.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The point-of-sale or POS industry has specific requirements for connectivity to peripheral devices, such as receipt printers, barcode scanners, card readers, cash drawers, etc. via the universal serial bus (USB) for data communications. This retail specific connectivity is called PoweredUSB, RetailUSB, and/or USB+Power, which are collectively referred to herein as “poweredUSB” because this platform adds power to the peripheral device.

In a typical POS system configuration, a peripheral device such as a cash register is connected to a desktop computer using a USB cable so that data can be passed from the cash register to the desktop computer for processing. If the peripheral device requires additional power that is not provided by the desktop computer through the USB connection, the peripheral device may be connected to an external power source to obtain the required power.

In some POS system configurations, USB hubs exist that provide power and data connectivity to peripheral devices while simultaneously interfacing with data processing units such as a desktop computer. Such USB hubs allow each peripheral device requiring individual power to obtain the required power through a USB connection to the USB hub while also allowing for each of the peripheral devices to share data with a computing device that includes processing unit (e.g. desktop computer) through the USB hub.

Such POS system configurations have several downsides. First, such configurations suffer from lack of mobility. In order to move such a POS system to a new physical location, extensive cables or physical movement of the desktop computer and USB hub is required. Additionally, USB hubs and their internal circuitry are routinely damaged by electrical shorts that occur from damaged cables, non-compliant connectors, non-poweredUSB connectors or a faulty peripheral. Finally, the point of sale processor has no easy upgrade/repair path when the processor hardware becomes outdated or requires maintenance.

Thus, there is a need for a POS system that provides increased modularity, robustness, while preserving the connection to legacy devices.

### BRIEF DESCRIPTION OF THE DRAWINGS

In the drawings:

FIG. 1 is a block diagram of an example point-of-sale processor system in which various embodiments may be practiced.

FIG. 2 is a circuit diagram of dataline protection circuitry.

FIG. 3A illustrates a front view of an example point-of-sale processor system that that couples a third party computing device to a powered USB device.

FIG. 3B illustrates a back view of an example point-of-sale processor system that that couples a third party computing device to a powered USB device

FIG. 4A illustrates an example point-of-sale processor system that couples a custom computing device to a powered USB device.

FIG. 4B illustrates an example point-of-sale processor system that that shows an embodiment of coupling a computing device to a powered USB device.

FIG. 5 illustrates a locking mechanism that that secures a computing device to a powered USB device.

FIG. 6 is a block diagram of a computer system on which embodiments of the invention may be implemented.

### DETAILED DESCRIPTION

In the following description, for the purposes of explanation, numerous specific details are set forth in order to provide a thorough understanding of embodiments of the invention. It will be apparent, however, that embodiments of the invention may be practiced without these specific details. In other instances, well-known structures and devices are shown in block diagram form in order to avoid unnecessarily obscuring the embodiments of the invention.

### General Overview

To increase the mobility and robustness of a POS system, a computing device such as a microcomputer can be directly coupled to a USB hub. The computing device can receive power through a power supply that is coupled, internally or externally, to the USB hub. The USB hub may include multiple poweredUSB ports that are configured to deliver power and data connectivity to peripheral devices. The USB hub may also provide a connection to facilitate the transfer of data between the computing device coupled to, and powered by, the USB hub and any peripheral devices connected to the poweredUSB ports.

The USB hub may also include dataline protection circuitry that includes sensors to help detect electro-static discharge conditions, over voltage conditions, short circuit conditions, overcurrent conditions, and under voltage conditions. When one or more of the conditions are detected, the system automatically disconnects power and data flow from the poweredUSB port where the condition is detected to prevent damage to the USB hub.

### Example Point of Sale Processor System

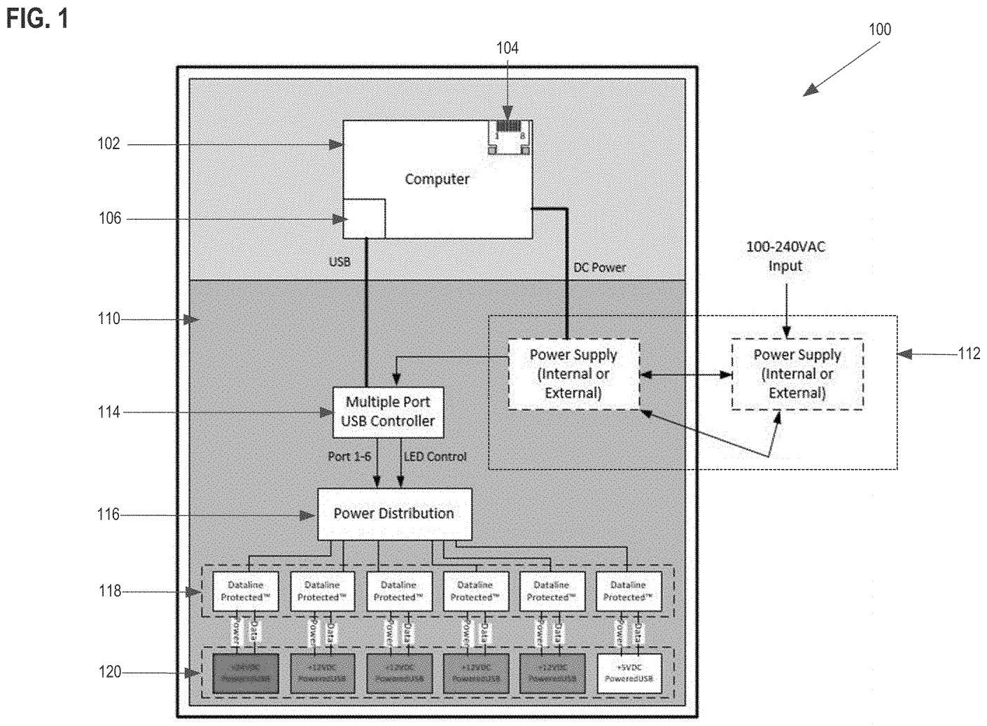

FIG. 1 is a block diagram of an example point-of-sale processor system in which various embodiments may be practiced. FIG. 1 is shown in simplified, schematic format for purposes of illustrating a clear example and other embodiments may include other elements.

In an embodiment, point-of-sale system 100 comprises a computing device 102 coupled directly to USB hub 110.

Computing device 102 is a computer that includes hardware capable of coupling computing device 102 directly to USB hub 110. Computing device 102 may be a microcomputer, smart phone, tablet computing device, PDA, laptop, or any other computing device capable of transmitting and receiving information and performing the functions described herein. Computing device 102 is coupled to a USB host 106 and a network card 104, as further described herein.

Computing device 102 may include a general purpose microprocessor such as central processing unit (CPU). A processor included in computing device 102 may utilize known processor design techniques including, but not limited to, superscalar architecture, simultaneous multithreading, fine-grained multithreading, speculative execution, branch prediction, out-of-order execution, and/or register renaming. Computing device 102 may include circuitry for executing instructions according to a predefined instruction set architecture. For example, the predefined instruction set architecture may be any of: x86®, ARM®, PowerPC®, MIPS®, Sparc®, RISC-V®, or other complex or reduced instruction set architecture.

Network card 104 may facilitate the communication of computing device 102 with one or more server computers through a wireless router (not illustrated in FIG. 1) coupled to an internet service provider. Network card 104 may also facilitate other types of communication technologies including but not limited to: BLUETOOTH, WiFi, satellite, or cellular technology.

USB host 106 may comprise one or more USB ports that facilitate the receiving and sending of data from and to USB hub 110.

In some embodiments, computing device 102 may comprise a low-powered embedded computing device or a single board computer. A single board computer, as defined herein, refers to is a computing device in which a single circuit board comprises memory, input/output, and a microprocessor. Computing device 102 may comprise any of a RASPBERRY PI computer, a NVIDIA Jetson, a tablet computer, a computer based on an ARM or x86 processor, or a mobile phone.

Computing device 102 may also include memory and storage components such RAM and internal persistent storage to facilitate the techniques discussed herein. Computing device 102 may also be configured with other mechanisms, processes, and functionality, depending upon a particular implementation.

Computing device 102 is configured to communicate with other devices, such as USB hub 110. The method of communication may be implemented with any type of medium and/or mechanism that facilitates the exchange of information between computing device 102 and USB hub 110. Furthermore, the communication may comprise any type of communications protocol, and may be secured or unsecured, depending upon the requirements of a particular application.

essing instructionsweredUSB device that provides power and USB data connectivity to peripheral devices through USB ports. USB hub 110 includes components such as power supply 112, multiple port USB controller 114, power distribution circuitry 116, dataline protection circuitry 118, and distribution unit 120 that includes multiple poweredUSB ports. As referred to herein, a poweredUSB port is a USB port that conforms to the PoweredUSB standard.

Power supply 112 comprises hardware that provides power to multiple port USB controller 114, power distribution circuitry 116 and computing device 102. Power supply 112 receives power from an electrical outlet such as a receptacle, typically at 100-240VAC. Power supply 112 converts received power from alternating current (AC) to direct current (DC) and provides DC power to computing device 102 and components of USB hub 110. In some embodiments, power supply 112 is housed or contained internally by USB hub 110. In other embodiments, power supply 112 is housed externally to USB hub 110.

Multiple port USB controller 114 includes programmatic logic and/or circuitry that controls the data flow to distribution unit 120. Multiple port USB controller 114 also includes programmatic logic and/or circuitry that controls the power flow to power distribution 116. Distribution unit 120 comprises multiple poweredUSB connections or ports that may be used to connect to or interface with peripheral devices. Power distribution 116 includes programmatic logic and/or circuitry that controls the power distribution to distribution unit 120. Power distribution 116 distributes power to each of the multiple poweredUSB connections of distribution unit 120 at 5V, 12V, or 24V.

In some embodiments, each of the multiple poweredUSB connections of distribution unit 120 are hot pluggable. Hot pluggable refers to the ability to add and remove peripheral devices to the point of sale processing system 100 while the system running and having the system automatically recognize the change without having to stop of shut down the system or any components thereof.

In some embodiments, USB hub 110 is configured to, using one or more components included in USB hub 110, receive, from computing device 102, data associated with a peripheral device that is connected to USB hub 110 through a poweredUSB connection. USB hub 110 is further configured to transmit the data to the peripheral device through the poweredUSB connection.

Dataline protection circuitry 118 includes circuitry that protects the multiple port USB controller 114 and/or other components of USB hub 110 from being damaged by electrical shorts that might occur from damaged cables, non-compliant connectors, non-poweredUSB connectors or a faulty peripheral device. In some embodiments, as shown in FIG. 1, a single dataline protection circuit is configured for each poweredUSB port in distribution unit 120.

Dataline protection circuitry 118 is configured to prevent short circuit conditions during a period of time when a power connection is being made. Dataline protection circuitry 118 is configured to cause a USB port to auto-reset back to normal operation once an abnormal condition is corrected. In some embodiments, Dataline protection circuitry 118 utilizes a Texas Instruments TPD3S716 microchip to facilitate the functionality discussed herein.

Dataline protection circuitry 118 is configured to offer short to PUSB rail protection up to 30V and short to ground protection on a USB VBUS. Dataline protection circuitry 118 is configured to provide a fault pin that indicates to the system if an over-current condition has occurred. The fault pin may also signal to the host system that a faulty condition is present. In one embodiment, dataline protection circuitry 118 is configured to integrate system level IEC 61000-4-2 and ISO 10605 ESD protection on its VBUS, VD+, and VD− pins. This prevents damage to the poweredUSB ports in distribution unit 120 when the electrostatic (ESD) energy contacts a port.

Without dataline protection circuitry 118, USB hubs 110 are susceptible to shorting the power to data lines which causes significant standard hub failures.

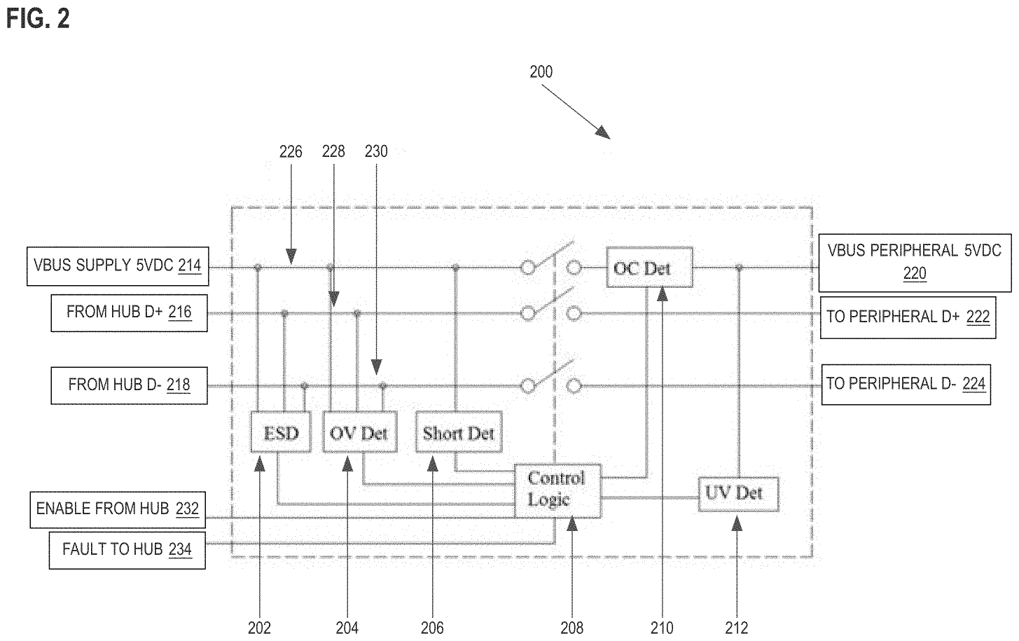

FIG. 2 is a circuit diagram of dataline protection circuitry 200. FIG. 2 is shown in simplified, schematic format for purposes of illustrating a clear example and other embodiments may include other elements.

In dataline protection circuitry 200, power is received from power distribution 116 through power line vbus supply 5VDC 214. Power is transmitted to a poweredUSB port in distribution unit 120 through vbus peripheral 5VDC 220. Data is received from USB hub 110 through from hub D+ 216 and from hub D− 218. Data is transmitted to a poweredUSB port in distribution unit 120 through to peripheral D+ 222 and to peripheral D− 224.

ESD 202 comprises a sensor that detects electro-static discharge events. The purpose of ESD 202 is to protect the data lines 228, 230 and power line 226 from electro-static discharge. ESD 202 prevents damage to a USB port due to an electrostatic event up to +/−8000 Volts when contacted and +/−15,000 Volts under air discharge. When either of these ESD conditions occurs, data lines 228, 230 and power line 226 are automatically disconnected from the upstream hub components. ESD 202 absorbs the high voltage event and maintains USB port integrity and prevents damage.

Overvoltage (OV) detection 204 comprises a sensor that detects if there is a condition on any of the data lines 228, 230 or power line 226 where the voltage is too high. The data lines 228, 230 and power line 226 are constantly monitored by OV detection 204 for abnormal voltages that are connected to the lines from 5.6V up to 18 V. If a high voltage is sensed, then data lines 228, 230 and power line 226 are automatically disconnected from the upstream hub components within 2 microseconds (2 μsec).

Short detection 206 comprises a sensor that detects if a short circuit condition is present. The short circuit could be to ground or either of the data lines 228, 230. If a low resistance is detected between the input power to either data lines 228, 230 or power line 226, then control logic 208 will isolate the upstream circuitry (i.e. disconnect data lines 228, 230 and power line 226 from the upstream hub components) to prevent damage within 4 microseconds (4 μsec).

Overcurrent (OC) detection 210 comprises a sensor that detects whether the current supplied to a peripheral device is excessive. Under USB specifications, if a peripheral device consumes more that 500 mA of USB 5V power, then the respective USB port is turned off/disconnected. OC detection 210 senses the current and complies with the USB specification.

The undervoltage (UV) detection 212 comprises a sensor that detects if a voltage level is in under a certain threshold when power is being supplied to a peripheral. At power-ON, the data lines 228, 230 and power line 226 line are disconnected from the upstream circuitry until the voltage reaches an acceptable level. In addition, if the voltage falls below an acceptable level of about approximately 3V then the USB connections for the port are turned off

Control logic 208 comprises circuitry or programmatic logic that receives data from sensor inputs 202, 204, 206, 210, 212 and allows USB data and power to flow through data lines 228, 230 and power line 226 to the peripheral 220, 222, 224 when safe conditions are present. If any data from sensor inputs 202, 204, 206, 210, 212 triggers a fault by control logic 208, control logic 208 relays a signal to upstream USB hub components via fault to hub 234, such as multiple port USB controller 114. Multiple port USB controller 114 then notifies computing device 102 of a fault condition, and that the USB port has terminated normal operation. Control logic 208 may also receive data from USB hub 110 through enable from hub 232.

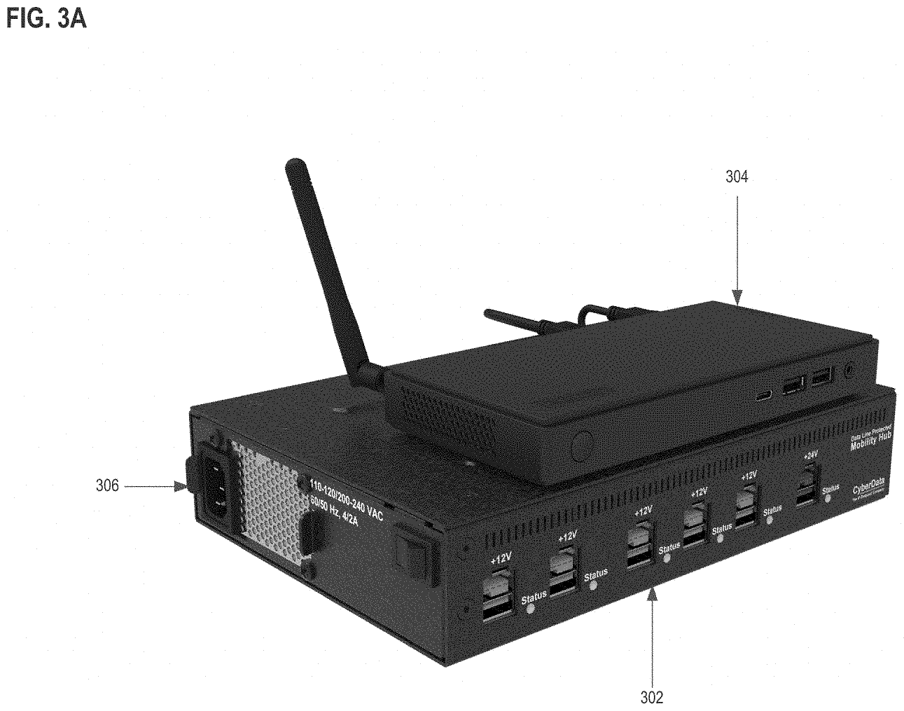

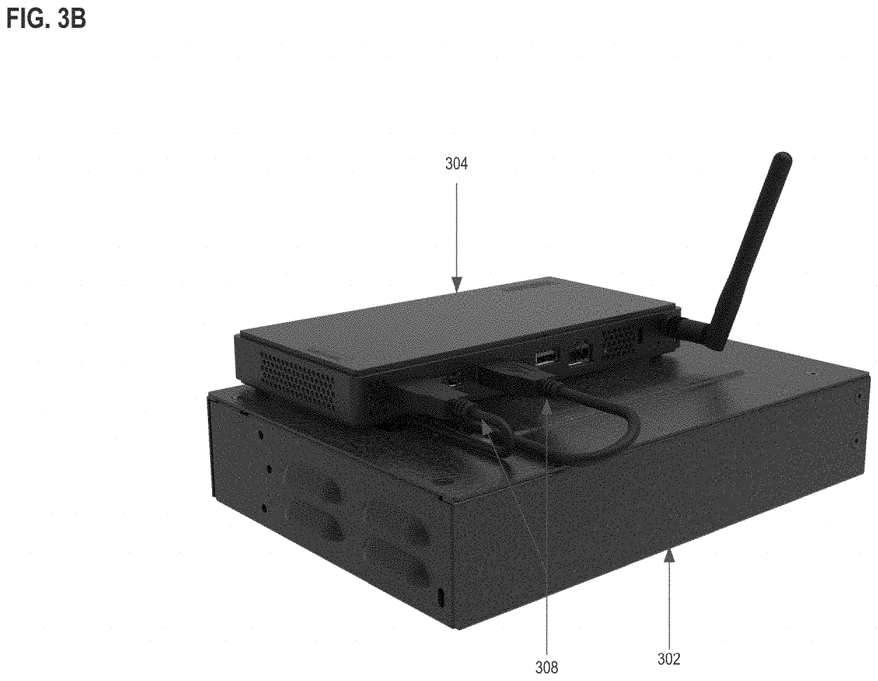

FIG. 3A illustrates a front view of an example point-of-sale processor system that that couples a third party computing device to a powered USB device. USB hub 302 comprises a powered USB device, such as USB hub 110 from FIG. 1. Third party computing device 304 comprises a computing device such as computing device 102 from FIG. 1, an embedded computing device, a single-board computer, or any other computing device. Third party computing device 304 receives power from USB hub 302, such as through a power supply 306 that is internal to or contained inside USB hub 302. In some embodiments, power supply 306 contained within USB hub 302 provides a sole source of power for third party computing device 304. Third party computing device 304 is coupled to USB hub 302. FIG. 3 illustrates a modular design, where the third party computing device can be detached from the powered USB device and can be modified, replaced or exchanged with a different computing device.

FIG. 3B illustrates a back view of an example point-of-sale processor system that that couples a third party computing device to a powered USB device. FIG. 3B shows the same configuration and components as FIG. 3A, including USB hub 302 and third party computing device 304. In addition, FIG. 3B includes external cable connections 308 that connect the USB hub 302 to third party computing device 304. A single cable of external cable connections 308 may comprise a USB cable capable of transmitting data and/or power between USB hub 302 and third party computing device 304.

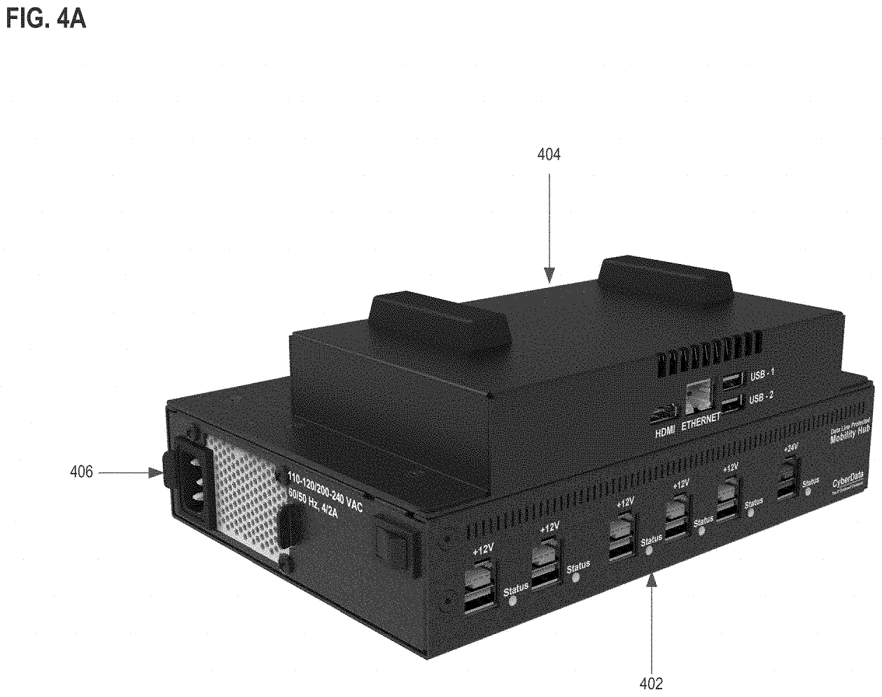

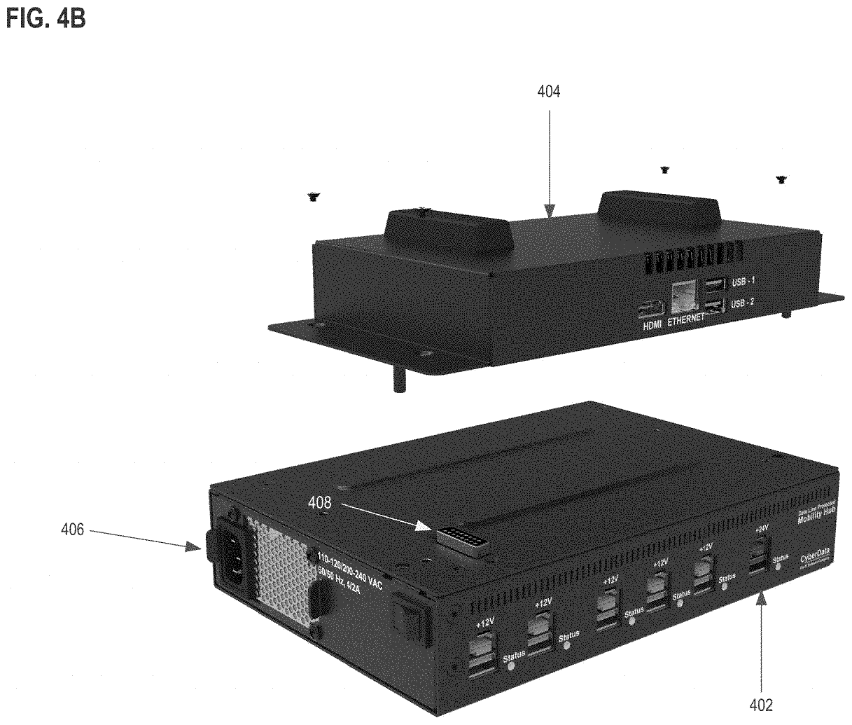

FIG. 4A illustrates an example point-of-sale processor system that that couples a custom computing device to a powered USB device. USB hub 402 comprises a powered USB device, such as USB hub 110 from FIG. 1. Custom computing device 404 comprises a computing device such as computing device 102 from FIG. 1, an embedded computing device, a single-board computer, or any other computing device. Custom computing device 404 receives power from USB hub 402, such as through a power supply 406 that is internal to or contained inside USB hub 402. In some embodiments, power supply 406 contained within USB hub 402 USB hub 402 provides a sole source of power for custom computing device 404. Custom computing device 404 is coupled to USB hub 402. FIG. 4A illustrates a modular design, where the custom computing device can be detached from the powered USB device and can be modified, replaced or exchanged with a different computing device.

FIG. 4B illustrates an example point-of-sale processor system that that shows an embodiment of coupling a custom computing device to a powered USB hub. FIG. 4B shows the same configuration and components as FIG. 4A, including USB hub 402 and custom computing device 404. In addition, FIG. 4B includes port 408 that connects the USB hub 402 to custom computing device 404. Additionally, as shown in FIG. 4B, custom computing device 404 includes an exterior surface that is attachable to an exterior surface of USB hub 402. When custom computing device 404 is fully attached to USB hub 402, such as illustrated in FIG. 4A, power supply 406 contained internally by USB hub 402 provides power to custom computing device 404 through port 408. As discussed herein, power supply 406 may provide a sole source of power to computing device 404. Port 408 may comprise any port capable of facilitating the transmission of power and/or data to computing device 404. FIG. 4B illustrates a modular design, where custom computing device 404 can be detached from USB hub 402 and can be modified, replaced or exchanged with a different computing device.

In some embodiments, no wires, cables, or cords are required to couple or connect computing device 404 to USB hub 402. For example, as shown in FIG. 4B, port 408 may directly connect to custom computing device 404 by attaching the exterior surfaces of USB hub 402 and custom computing device 404.

In some embodiments, a point-of-sale processor system is configured in a monolithic design. Using a monolithic design, a computing device is directly coupled to a USB hub and the computing device cannot be detached from the USB hub.

In some embodiments, a computing device is configured to be exchanged with a new computing device with different processor hardware as an upgrade path without modifying any peripheral devices that are connected to the USB hub through poweredUSB connections.

### Locking Mechanism

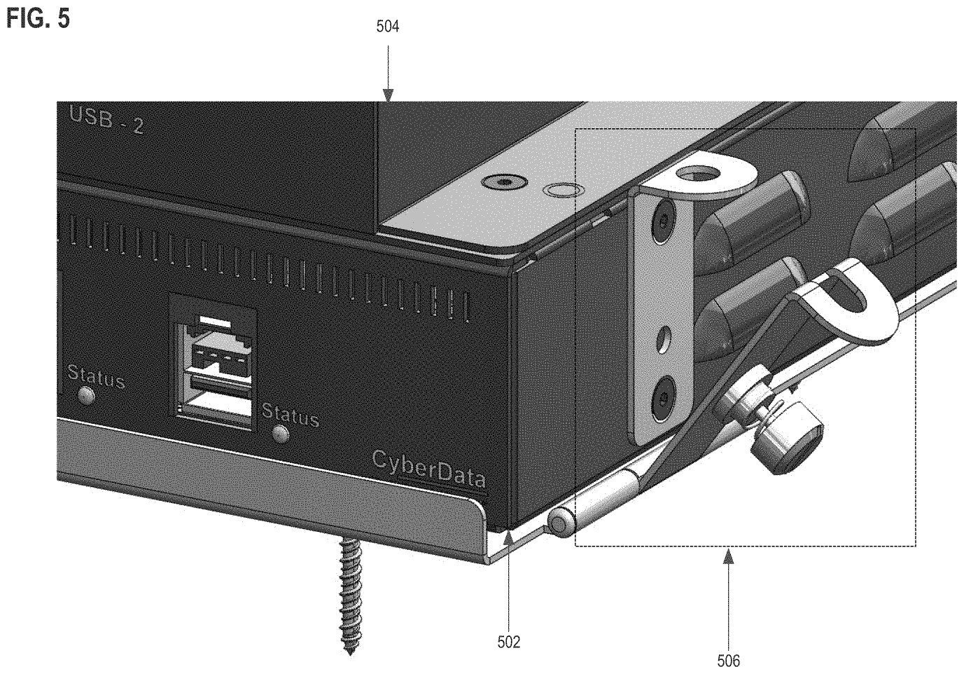

FIG. 5 illustrates a locking mechanism that that secures a computing device to a powered USB device. USB hub 502 comprises a powered USB device, such as USB hub 110 from FIG. 1. Computing device 504 comprises a computing device such as computing device 102 from FIG. 1, an embedded computing device, a single-board computer, or any other computing device. Locking mechanism 506 secures USB hub 502 to computing device 504. The purpose of locking mechanism is to prevent or mitigate the theft of USB hub 502 and/or computing device 504.

### Green Power Control

USB hub 110 may be programmatically turned off by computing device 102 to remove power from poweredUSB ports in distribution unit 120 to save energy. In some embodiments, USB hub 110 is configured to support direct control of the poweredUSB ports in distribution unit 120 from computing device 102. USB hub 110 is configured to generate and transmit a signal that indicates to shut off power to poweredUSB ports in distribution unit 120 in response to computing device 102 going into sleep mode or standby mode.

For example, at night or when a poweredUSB port in distribution unit 120 is not being used by a peripheral device for a threshold amount of time, computing device 102 may automatically go into sleep mode. Alternatively, a user can place the computing device 102 into sleep mode manually. Either of these events triggers a shut-off of power to all poweredUSB ports in distribution unit 120 to save energy while the unit is not in use.

In some embodiments, energy saving techniques discussed above are enabled by removing jumper JP2 on a base printed circuit board assembly of USB hub 110. By removing jumper JP2, USB hub 110 automatically wakes up when the computing device 102 wakes up, either manually or by Wake-On-LAN.

### Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

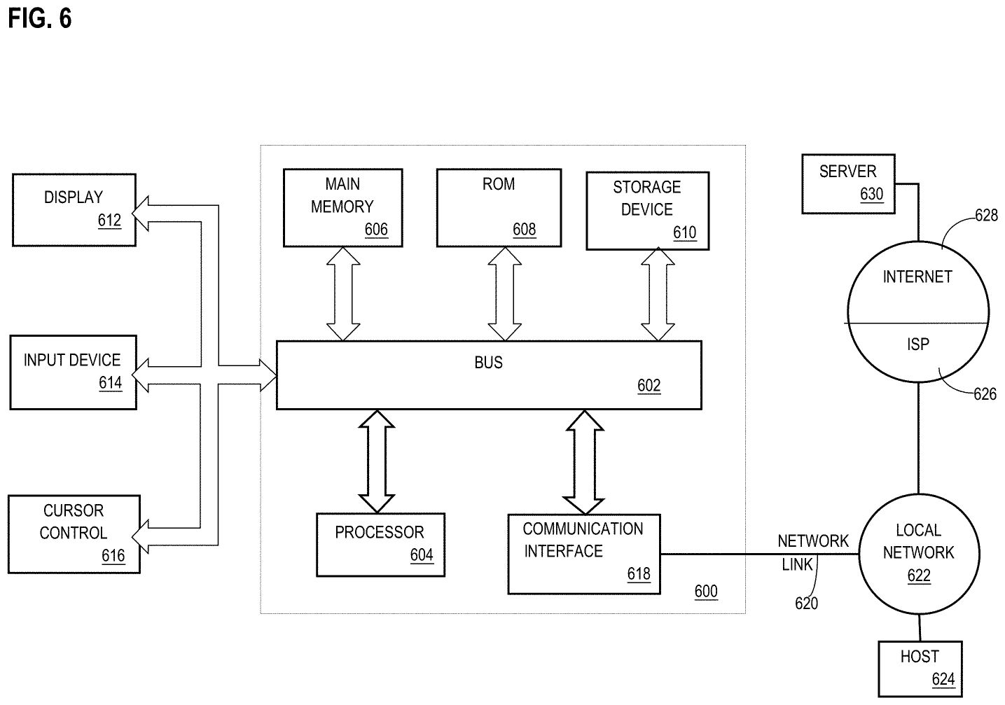

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disk such as CD-ROM or DVD-ROM, and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on display 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an interne of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to bus 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or no SQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A point of sale processor system comprising:
a computing device comprising a processing unit and a first power interface, the first power interface coupled to the processing unit to receive power from a power supply unit;
the power supply unit coupled to the USB hub to supply power to the USB hub and computing device;
the USB hub comprising: a distribution unit comprising multiple poweredUSB connections operating at individual voltage levels, a second power interface coupled to the power supply unit to provide power to the distribution unit and the computing device;
wherein the USB hub is configured to:
receive, from the computing device, data associated with a particular peripheral device that is connected to the USB hub through a particular poweredUSB connection of the multiple poweredUSB connections;
transmit the data to the particular peripheral device through the particular poweredUSB connection of the multiple poweredUSB connections.

2. The point of sale processor system of claim 1, wherein the USB hub interfaces with the computing device using: an internal connector for power and USB, or a first external cable for USB and a second external cable for power.

3. The point of sale processor system of claim 1, wherein the distribution unit distributes power to each of the multiple poweredUSB connections at 5V, 12V, or 24V.

4. The point of sale processor system of claim 1, wherein each of the multiple poweredUSB connections are hot pluggable.

5. The point of sale processor system of claim 1, wherein the computing device is not detachable from the USB hub.

6. The point of sale processor system of claim 1, wherein the computing device is detachable from the USB hub.

7. The point of sale processor system of claim 1, wherein the computing device is detachable from the USB hub and is configured to be exchanged with a new computing device with different processor hardware as an upgrade path without modifying one or more peripheral devices that are connected to the USB hub through one or more of the multiple poweredUSB connections.

8. The point of sale processor system of claim 1, wherein the USB hub is further configured to determine that an electro-static discharge condition is satisfied and in response, disconnect power and data flow from one of the multiple poweredUSB connections.

9. The point of sale processor system of claim 1, wherein the USB hub is further configured to determine that an over voltage condition is satisfied and in response, disconnect power and data flow from one of the multiple poweredUSB connections.

10. The point of sale processor system of claim 1, wherein the USB hub is further configured to determine that a short circuit condition is satisfied and in response, disconnect power and data flow from one of the multiple poweredUSB connections.

11. The point of sale processor system of claim 1, wherein the USB hub is further configured to determine that an overcurrent condition is satisfied and in response, disconnect power and data flow from one of the multiple poweredUSB connections.

12. The point of sale processor system of claim 1, wherein the USB hub is further configured to determine that an under voltage condition is satisfied and in response, disconnect power and data flow from one of the multiple poweredUSB connections.

13. The point of sale processor system of claim 1, wherein the USB hub is configured to determine that the computing device has gone into sleep mode or standby mode and in response, disconnect power from the multiple poweredUSB peripheral connections.

14. The point of sale processor system of claim 1, further comprising a locking mechanism to secure the computing device to the USB hub.
